(19) United States
(12) Patent Application Publication
(10) Pub. No.: US 2019/0195197 A1
(43) Pub. Date: Jun. 27, 2019

(54) ROTOR ARRESTING DEVICE FOR A WIND TURBINE AND METHOD

(71) Applicant: Wobben Properties GmbH, Aurich (DE)

(72) Inventor: Jochen RÖER, Ganderkesee (DE)

(21) Appl. No.: 16/331,504

(22) PCT Filed: Aug. 24, 2017
(86) PCT No.: PCT/EP2017/071279

§ 371 Date: Mar. 7, 2019

(30) Foreign Application Priority Data
Sep. 9, 2016 (DE) 10 2016 116 945.5

(51) Int. Cl. F03D 7/02; F03D 80/50

(52) U.S. Cl. CPC F03D 7/0248; F03D 1/00; F03D 80/50

(57) ABSTRACT

A rotor arresting device for a wind turbine, to a wind turbine and to methods for arresting and for moving a rotor of a wind turbine. A rotor arresting device for a wind turbine having a rotor and a rotation assembly which is connected to the rotor in a rotationally rigid manner, comprising at least one coupling device which can be arranged on a static assembly, which is positionally fixed relative to the rotation assembly, of the wind turbine, having a first actuator, a second actuator, and a coupling element which is connected to the first and the second actuator, and a counterpart coupling element which can be arranged on the rotation assembly, wherein the coupling element and the counterpart coupling element are releasably connected, preferably in a form-fitting manner, in an arresting position of the coupling device.

### BACKGROUND

### Technical Field

The invention relates to a rotor arresting device for a wind turbine, to a wind turbine and to methods for arresting and for moving a rotor of a wind turbine.

### Description of the Related Art

A wind turbine converts the energy of the wind into electrical energy. The dominant design form of wind turbines is the three-bladed horizontal-axis wind turbine in which, during operation, the rotor is situated on the windward side and its machine housing is arranged on a tower and actively tracks the wind direction.

The rotor blades of a wind turbine are generally fastened to a common hub. This hub is preferably connected to a rotation assembly in a rotationally rigid manner. In the case of wind turbines with a direct drive, that is to say without a gearbox for transmission, the rotor generally drives a generator rotor. In the case of wind turbines with gearbox, the rotation assembly generally comprises a rotor shaft which connects the rotor and a gearbox to one another and thus converts the rotational movement of the rotor into a gearbox output movement and then transmits this gearbox output movement in turn to a generator.

What is to be understood by a rotor in the context of this application is the aerodynamic rotor of a wind turbine having, typically, three rotor blades. What is to be understood by a generator rotor in the context of this application is an electrodynamic rotor of a generator. A generator in the context of this application comprises both inner-rotor generators, in which a generator rotor rotates radially within a stator, and outer-rotor generators, in which a generator rotor rotates radially outside around a stator.

It is desirable in various situations for the rotor of a wind turbine to be arrested. For example, it is frequently required for the rotor to be arrested in order to carry out repair and/or maintenance work, for example in the interior of the nacelle or in the region of the hub. Furthermore, it is required, for example, for the rotor to be arrested when the wind turbine is mounted and/or demounted. For example, high arresting forces and/or arresting torques occur in order to hold a rotor in a defined position if not all of the intended rotor blades are arranged and the rotor is situated in an unstable position. As a result, the rotor blades, which are not uniformly arranged about a point of rotation, produce a high torque with respect to this point of rotation. Furthermore, it is frequently required for the rotor to be arrested in a desired position with a high degree of accuracy such that position-dependent repairs and/or maintenance work and/or assembly work can be carried out.

Current rotor arresting devices primarily have the aim of providing secure arresting. This is explained in particular by the fact that corresponding safety measures must be put in place for persons working on the wind turbine. Therefore, there is primarily provision in known rotor arresting devices for combinations of bolts and preferably a plurality of openings. Openings are preferably arranged on a generator rotor of a generator, in particular on a rotor support, the passage direction of which openings is preferably arranged substantially parallel to an axis of rotation of the generator. Bolts which correspond to the openings and which can be arranged in the openings are preferably arranged on the generator stator, in particular on a stator support. The arrangement of the bolts within the openings means that the generator rotor, and hence also the aerodynamic rotor, can be arrested.

Although such a rotor arresting device can, on the one hand, provide secure arresting of the rotor, positioning of the rotor is possible only at the positions at which openings are provided on the rotation assembly. Furthermore, it is required, for example for mounting rotor blades, to release the arresting action after mounting a first rotor blade in order to rotate the rotor into the position for mounting the second rotor blade and to arrest it again in said position. This results in high costs and a large degree of effort in a wide variety of application regions. Although the existing systems and methods for arresting wind turbine rotors offer various advantages, further improvements are desirable.

The German Patent and Trademark Office has searched the following prior art in the priority application pertaining to the present application: DE 10 2010 020 355 A1 and GB 2 535 331 A.

### BRIEF SUMMARY

According to a first aspect of the present invention, provided is a rotor arresting device for a wind turbine having a rotor and a rotation assembly which is connected to the rotor in a rotationally rigid manner, comprising at least one coupling device which can be arranged on a static assembly, which is positionally fixed relative to the rotation assembly, of the wind turbine, having a first actuator, a second actuator, a coupling element which is connected to the first and the second actuator, and a counterpart coupling element which can be arranged on the rotation assembly, wherein the coupling element and the counterpart coupling element are releasably connected, preferably in a form-fitting manner, in an arresting position of the coupling device, and wherein the coupling device can be brought from a release position into the arresting position by means of a first coupling movement of the first actuator and/or by means of a second coupling movement of the second actuator, and wherein the first coupling movement has a first setting direction component and the second coupling movement has a second setting direction component, wherein the first setting direction component and the second setting direction component are directed in opposite directions.

The rotation assembly is connected to the rotor in a rotationally rigid manner. If not explicitly otherwise described, a rotor is to be understood as meaning the assembly comprising at least one rotor blade and a hub on which the at least one rotor blade is arranged. The rotor often also has a spinner. The rotation assembly can comprise, for example, a rotor support and/or a rotor shaft which are or is arranged on the rotor hub in a rotationally rigid manner. The rotation assembly can preferably also comprise a generator rotor. Furthermore, the rotation assembly preferably comprises any component which, by means of a rotation of the rotor, is likewise set into a rotational movement.

In addition to the rotation assembly, a wind turbine generally comprises a static assembly which is positionally fixed in relation to the rotation assembly. The static assembly particularly comprises such elements which are arranged within the nacelle and which perform no rotational movement about an axis of rotation of the rotor. The static assembly is thus positionally fixed in relation to the rotation assembly. However, the static assembly, together with the nacelle, can as a rule be rotated about a substantially vertical axis with respect to the tower and/or the foundation of the wind turbine, since wind turbines generally have a wind direction tracking system, with the result that the nacelle can rotate about an axis parallel to the longitudinal axis of the tower. Consequently, the static assembly, which is arranged within the nacelle, also rotates with respect to a point outside of the nacelle, in particular with respect to the ground on which the wind turbine is erected. In the context of this application, the term “positionally fixed” is therefore to be understood in relation to the rotating rotation assembly. The static assembly comprises, for example, a generator stator, a journal, a machine support, a generator housing, or a gearbox housing. Furthermore, the static assembly preferably comprises an element on which the coupling device can be arranged.

The at least one coupling device has at least two actuators, namely the first actuator and the second actuator, wherein an actuator is preferably to be understood as meaning an element which can move itself and/or a further element into a defined position. In particular, the first actuator and the second actuator are arranged and designed in such a way that they can move the coupling element, to which the actuators are connected, into different positions.

Furthermore, the rotor arresting device comprises the counterpart coupling element, which, in the installed state and/or in the operating state, is arranged on the rotation assembly of the wind turbine. The counterpart coupling element and the coupling element are arranged and designed in such a way that they can form a releasable, in particular form-fitting, connection. This form-fitting connection preferably results in the rotation assembly being prevented from rotating about an axis of rotation. This releasable connection of the coupling element and of the counterpart coupling element is formed as soon as the coupling element is situated in an arresting position.

As already stated in the foregoing, the connection between the coupling element and the counterpart coupling element is configured to be releasable. The coupling element can also be brought into a position in which the connection is released, that is to say no connection between coupling element and counterpart coupling element is present. In this position, the coupling element and the counterpart coupling element are not connected to one another, this position being referred to as release position. In the release position, the rotation assembly can rotate about its axis of rotation without it being prevented from rotating about this axis of rotation by the coupling element or the coupling device. For a coupling element there preferably result one, two or more release positions in which it is thus not connected to the counterpart coupling element. Moreover, one, two or more arresting positions can also result for a coupling element. This can be achieved, for example, by the arrangement of more than one counterpart coupling element, wherein the one coupling element is then designed and arranged to reach more than one counterpart coupling element.

From this release position, the coupling element can be moved into the arresting position by the first actuator and/or by the second actuator by means of a first coupling movement of the first actuator and/or by means of a second coupling movement of the second actuator. The first coupling movement and the second coupling movement have a direction component which is directed in opposite directions. This so-called setting direction component is preferably oriented substantially tangentially to the rotation assembly. The first coupling movement comprises the first setting direction component, which is preferably oriented in a first tangential direction of the rotation assembly. The second coupling movement comprises the second setting direction component, which is preferably oriented in a second tangential direction of the rotation assembly, wherein the first tangential direction and the second tangential direction are opposite to one another.

In a preferred embodiment variant of the rotor arresting device, there is provision that it comprises two or more coupling devices and/or two or more first actuators and/or two or more second actuators and/or two or more coupling elements. The two or more coupling devices are preferably designed according to the above description of the coupling device. It is furthermore preferable for the two or more coupling devices to be arranged equidistantly on a circumference of the rotation assembly. On account of the generally high forces and/or torques which occur during the arresting of a rotor of a wind turbine, it is preferable for two or more coupling devices to be arranged. Six or more coupling devices are preferably arranged. In particular, it is preferable for two or more coupling devices to be arranged if one, two or more coupling devices or their coupling elements are temporarily not situated in the arresting position, for example in order to form a connection with a counterpart coupling element which is spaced apart from a current arresting position in the tangential direction. In order that the movement of one, two or more coupling elements toward a counterpart coupling element spaced apart in the tangential direction can occur while ensuring rotor arresting, a sufficient number of coupling elements should still be situated in an arresting position during this movement. The sufficient number of coupling elements in preferably one, two or more. A cyclical activation of the coupling devices can thus also occur.

Moreover, it can be advantageous that the coupling device comprises two or more first actuators and/or two or more second actuators. The arrangement of two more first and/or second actuators can ensure an improved movement of the coupling element. Moreover, in certain embodiment variants, a plurality of actuators can also be used in a space-saving manner, for example if a large actuator is replaced by a plurality of small ones. Moreover, it can be advantageous that two or more coupling elements are used per coupling device, with the result that, for example, better force distribution can be achieved.

According to a further preferred embodiment variant of the rotor arresting device, there is provision that the first coupling movement has a first coupling direction component and the second coupling movement has a second coupling direction component, wherein the first coupling direction component and the second coupling direction component are directed in the same direction, wherein furthermore the first coupling direction component and the second coupling direction component is preferably directed from the coupling element toward the counterpart coupling element. A coupling movement preferably comprises in particular a coupling direction component and a setting direction component. In this embodiment variant, there is preferably provision that the first coupling movement and the second coupling movement each have a movement component which is directed in the same direction, that is to say the coupling direction component, and a movement component which is directed in the opposite direction, that is to say the setting direction component. The coupling direction component of the coupling movement is primarily provided to move the coupling element from a release position into an arresting position. By contrast, the setting direction component of the coupling movements is oriented at least in part orthogonally to the coupling direction component and thus is preferably primarily provided to move the coupling element in a tangential direction of the rotation assembly. As a result of the first and second coupling direction component and the first and second setting direction component of the first and second coupling movement, the first actuator and the second actuator are preferably arranged in a V-shaped arrangement. Furthermore, as a result of a tangential force on the coupling element, there preferably result no exclusive transverse forces on the actuators or the coupling element, and therefore the risk of jamming is reduced.

A further preferred development of the rotor arresting device is distinguished by the fact that the first coupling direction component and/or the second coupling direction component are or is oriented parallel to an axis of rotation of the rotation assembly of the wind turbine. In this embodiment variant, the counterpart coupling element is preferably arranged at a location of the rotation assembly which is accessible for example on the end side for the coupling element, with the result that the coupling element can be fed to the counterpart coupling element with an axial movement. The counterpart coupling element is preferably arranged on an end side of one or more elements of the rotation assembly. Furthermore preferably, the counterpart coupling element is arranged on a radial circumferential surface of one or more elements of the rotation assembly, but accessible by a coupling element moved in the axial direction.

Furthermore, there is preferably provision that the first coupling direction component and/or the second coupling direction component are or is oriented orthogonally and/or radially to the axis of rotation of the rotation assembly of the wind turbine. In this embodiment variant, the counterpart coupling element is preferably arranged on a radial circumferential surface of the rotation assembly or on an element of the rotation assembly, with the result that the coupling element can be brought into connection with the counterpart coupling element in that the coupling element performs a radial and/or orthogonal movement to the axis of rotation of the rotation assembly. Furthermore preferably, the counterpart coupling element is arranged on an end face of the rotation assembly or on one or more elements of the rotation assembly, wherein the counterpart coupling element arranged in such a way can be brought into connection with a coupling element moved orthogonally and/or radially to the axis of rotation.

In a further preferred embodiment variant of the rotor arresting device, there is provision that the coupling device can be brought from the arresting position into the release position by means of a first decoupling movement of the first actuator and/or by means of a second decoupling movement of the second actuator, and/or wherein the first decoupling movement has a first release direction component and the second decoupling movement has a second release direction component, wherein the first release direction component and the second release direction component are directed in opposite directions, and/or wherein the first decoupling movement has a first decoupling direction component and the second decoupling movement has a second decoupling direction component, wherein the first decoupling direction component and the second decoupling direction component are directed in the same direction.

The first decoupling movement is preferably parallel to the first coupling direction component, wherein the latter is furthermore preferably directed in an opposite direction. Furthermore preferably, the second decoupling direction component is parallel to the second coupling direction component, wherein the second coupling direction component is directed in an opposite direction to the second decoupling direction component. Moreover, the first release direction component can be oriented parallel to the first setting direction component, wherein they are preferably directed in opposite directions. Furthermore, the second release direction component can be oriented parallel to the second setting direction component, wherein these are preferably directed in opposite directions. The first decoupling movement and/or the second decoupling movement are particularly designed to move the coupling element away from the counterpart coupling element. In particular, the first decoupling movement and/or the second decoupling movement are or is designed to release the releasable connection between the coupling element and the counterpart coupling element.

According to a further particularly preferred embodiment variant of the rotor arresting device, there is provision that the first actuator and the second actuator are each designed to be activatable independently of one another. Consequently, the first actuator can preferably carry out the first coupling movement and/or the first decoupling movement independently of the second coupling movement and/or of the second decoupling movement of the second actuator. However, since the first actuator and the second actuator are each connected to the coupling element and to the static assembly, the movement components of the first actuator and/or of the second actuator are as a rule independent of one another. Moreover, there is the possibility that the first actuator or the second actuator is switched to a force-free state, with the result that the actuator which is respectively not switched to a force-free state codetermines the movement of the actuator which is respectively switched to a force-free state. This preferably also applies if the forces of the one actuator exceed the oppositely acting forces of the other actuator.

It is furthermore preferred that the first actuator and/or the second actuator comprise or comprises an extendable cylinder. In this embodiment variant, the first actuator and/or the second actuator preferably carry or carries out the above-described movements by means of the extendable cylinder. This cylinder is preferably guided by a further element. The cylinder is preferably situated within a sleeve, wherein the sleeve furthermore preferably guides a radial circumferential surface of the cylinder. Moreover, the sleeve can be rotatably arranged on the static assembly.

A further particularly preferred embodiment variant of the rotor arresting device provides that the first actuator and/or the second actuator comprise or comprises a hydraulic cylinder or are or is designed as a hydraulic cylinder, wherein the hydraulic fluid is preferably water. Hydraulic cylinders are preferably distinguished by the fact that they can exert a large force in at least one linear force direction. Furthermore, hydraulic cylinders are distinguished by the fact that they can also hold large forces stationary. A hydraulic cylinder is generally a working cylinder operated by means of fluid. Hydraulic cylinders are also referred to as a hydraulic linear motor. The first and/or second actuator, in particular the first and/or second hydraulic cylinder, are or is preferably designed and arranged to be able to apply a torque of 100 to 1,000 kNm to the rotation assembly. The (external) torque originating from the rotation assembly, in particular the rotor, and to be taken up by the static assembly, in particular the stator, can lie in an order of magnitude of up to or even above 10,000 kNm. Since preferably a plurality of first and/or second actuators are provided, the torques to be applied by the actuators can be considerably lower.

In a hydraulic cylinder, the energy from the hydraulic fluid, which is preferably provided from a hydraulic pressure source, is converted into a simply controllable, preferably rectilinearly acting, force. Hydraulic cylinders preferably comprise as main constituent parts a tubular element with a cavity which has a cross section orthogonal to the longitudinal axis of the cavity, and a cylinder which is arranged within said cavity. In the present application case, the hydraulic fluid provided is preferably water since the otherwise also customary hydraulic fluid oil can lead to disadvantages during a malfunction of the hydraulic system. Particularly problematic here is the leaking-out of oil onto other components and/or onto the coupling elements or counterpart coupling elements, since the arresting functionality could be reduced as a result. However, under certain circumstances, oil can also be used as the hydraulic fluid.

Furthermore preferably, the first actuator and/or the second actuator have or has a nonreturn valve. In particular, nonreturn valves designed as load-holding valves prevent a situation in which loads on cylinders and/or actuators can be reduced in an uncontrolled manner. Such a holding mechanism is of great advantage particularly in the present application field of rotor arresting for wind turbines. In particular, the provision of a nonreturn valve can avoid or reduce the risk of unwanted release of the connection between coupling element and counterpart coupling element.

A further preferred development of the rotor arresting device is distinguished by the fact that the first actuator and/or the second actuator can be rotatably arranged on the static assembly and/or wherein the first actuator and/or the second actuator are or is rotatably connected to the coupling element. The first actuator and/or the second actuator are or is preferably rotatable about an axis, wherein this axis is arranged on the static assembly or in a region adjoining the static assembly. Further preferably, the first actuator and/or the second actuator are or is rotatable about an axis, wherein this axis is arranged on the coupling element or in a region adjoining the coupling element.

Furthermore, there is preferably provision that the first actuator and/or the second actuator are or is rotatably connected to the static assembly in such a way that the first actuator and/or the second actuator are or is rotatable about an axis which is oriented parallel to the axis of rotation of the rotation assembly of the wind turbine. In this embodiment variant, the first actuator and/or the second actuator are or is rotatable in a plane which is oriented orthogonally to the axis of rotation of the rotation assembly. This plane is preferably substantially surface-parallel to the plane of rotation of the rotor.

It is further preferable that the first actuator and/or the second actuator are or is rotatably connected to the static assembly in such a way that the first actuator and/or the second actuator are or is rotatable about an axis which is oriented orthogonally and/or radially to the axis of rotation of the rotation assembly of the wind turbine. According to a further preferred embodiment variant of the rotor arresting device, there is provision that the first actuator and/or the second actuator are or is rotatably connected to the coupling element in such a way that the first actuator and/or the second actuator are or is rotatable about an axis which is oriented parallel to the axis of rotation of the rotation assembly of the wind turbine.

A further particularly preferred embodiment variant of the rotor arresting device provides that the first actuator and/or the second actuator are or is rotatably connected to the coupling element in such a way that the first actuator and/or the second actuator are or is rotatable about an axis which is oriented orthogonally and/or radially to the axis of rotation of the rotation assembly of the wind turbine. In a particularly preferred embodiment variant of the rotor arresting device, there is provision that the actuators are rotatably connected to the static assembly and to the coupling element. It is thus possible to achieve a maximum flexibility of the movement direction of the first actuator and/or of the second actuator in combination with the coupling element. In particular, particularly many degrees of freedom are thus provided for the kinematics of the coupling device.

According to a further particularly preferred embodiment variant of the rotor arresting device, there is provision that the counterpart coupling element is arranged on a counterpart coupling device which is preferably ring-shaped, and wherein the counterpart coupling device can be arranged on the rotation assembly and/or wherein the counterpart coupling element is designed as a toothing recess. The ring-shaped counterpart coupling device preferably has a plurality of counterpart coupling elements which are furthermore preferably arranged equidistantly on the circumference of the counterpart coupling device.

The counterpart coupling device can preferably be designed as a constituent part of an existing element of the rotation assembly or be arranged on one element or two or more elements of the rotation assembly. The counterpart coupling device can preferably be an internally toothed circumference of the generator rotor, in particular of a rotor support. Furthermore preferably, the counterpart coupling device can be an externally toothed circumference of the generator rotor, in particular of a rotor support. Furthermore preferably, the counterpart coupling device can be a toothed end side of the generator rotor, in particular of a rotor support. The counterpart coupling device can alternatively preferably also be a separate element, for example a disk which is arranged on the rotation assembly in a rotationally rigid manner. Furthermore preferably, the counterpart coupling device can also be arranged on the input and/or output side of a gearbox of the wind turbine. With particular preference, the counterpart coupling element takes the form of a toothing recess. Two adjacent toothing recesses preferably form between them a tooth. The arrangement of a plurality of toothing recesses is particularly preferred.

A preferred development of the rotor arresting device is distinguished by the fact that the counterpart coupling device comprises a plurality of segment plates or consists of a plurality of segment plates. Furthermore, it is preferable that a device of the stator assembly comprises a plurality of segment plates or consists of a plurality of segment plates. Such segment plates preferably have at least one radial portion which forms a segment of a supporting structure of a counterpart coupling device and/or of a device of the stator assembly and has, for example, a plurality of reinforcing struts, the reinforcing struts being designed to take up compressive, tensile and shear forces. A plurality of segment plates are preferably arranged on one another in a plane such that they together form a plate ring, and a plurality of segment plates are stacked in the plate rings formed in such a way that they together form a plate bundle. In particular, the radial portion is preferably designed to form, in conjunction with the radial portions of further segment plates, a supporting structure of a counterpart coupling device and/or of a device of the stator assembly.

This configuration has the advantage, inter alia, that a counterpart coupling device and/or a device of the stator assembly can be produced and/or transported in a time and/or cost-effective manner.

Furthermore preferably, a plurality of through-openings which are adapted to guide through corresponding bracing elements are formed in the radial portion. The through-openings are preferably arranged along two or more spaced-apart circular arc lines, wherein the circular arc lines are preferably formed concentrically. With particular preference, in one embodiment with a first circular arc line and a second circular arc line, the through-openings on a first circular arc line are arranged offset in the circumferential direction to the through-openings on a second circular arc line. Furthermore preferably, the through-openings are arranged equidistantly to one another on their respective circular arc lines. This arrangement has the following advantage: the segment plates can be stacked on top of one another in an overlapping manner, with the result that the “seams” between the segment plates which adjoin one another in a ring plane are offset with respect to one another. At the same time, the equidistant, in particular two or more-rowed, arrangement of the through-openings allows an axial bracing of the overlapping segment plates. The thus produced static friction between the plates significantly increases the load-bearing capacity of the plate bundles and can contribute to a better damping behavior of acoustic vibrations which are emitted during the operation of the wind turbine.

The bracing elements are preferably designed to fixedly interconnect segment plates which are stacked on top of one another. The bracing elements preferably take the form of threaded rods, screws, bracing cables or the like. For the bracing, pressure distribution elements are preferably arranged at the ends of the bracing elements and are designed to distribute the bracing forces to as large a surface area as possible of the segment plates. The pressure distribution elements are designed, for example, as disks, rings, ring segments, sleeves or the like.

Furthermore preferably, a plurality of material weakenings or cutouts are arranged between the reinforcing struts in the radial portion. The material weakenings or cutouts preferably have the effect of weight reduction. The structure of the reinforcing struts is preferably obtained by means of laser cutting, water jet cutting, stamping or—particularly preferably—punching.

With particular preference, the through-openings and/or the reinforcing struts are in each case formed in the third radial portion by means of punching a base plate, wherein preferably, in the case of the reinforcing struts, material regions are punched out or stamped adjacent to the struts to be formed.

In a preferred embodiment variant of the rotor arresting device, there is provision that the counterpart coupling element designed as a toothing recess substantially has a semicircular geometry and/or the coupling element has a cylindrical geometry. In the embodiment variant with a toothing recess with a semicircular geometry and a coupling element with a cylindrical geometry, wherein this cylindrical geometry can preferably be arranged in the semicircular geometry of the toothing recess, a particularly good releasable connection between coupling element and counterpart coupling element that can be produced quickly can be achieved. In particular, jamming of the coupling element in the toothing recess can be avoided. Furthermore, in the case of the coupling element being positioned between two toothing recesses, a quick connection between coupling element and counterpart coupling element can nevertheless be achieved in that a tangential movement of the coupling element and/or of the counterpart coupling element is carried out, with the result that the coupling element can be positioned in the toothing recess.

A further preferred development of the rotor arresting device is distinguished by the fact that the rotor arresting device comprises a plurality of counterpart coupling elements which are preferably designed as semicircular toothing recesses and furthermore are spaced apart from one another by preferably less than 45 degrees, and/or less than 30 degrees, and/or less than 25 degrees, and/or less than 20 degrees, and/or less than 15 degrees, and/or less than 10 degrees, and/or less than 7.5 degrees, and/or less than 5 degrees, and/or less than 2 degrees, and/or less than 1 degree.

Furthermore, there is preferably provision that the rotor arresting device comprises an emergency power supply which is preferably designed as one, two or more power accumulators, wherein the power accumulators are or comprise batteries in particular. Such an emergency power supply can ensure a secure supply of the components of the rotor arresting device, with the result that rotor arresting can be ensured even during a power failure.

According to a further particularly preferred embodiment variant of the rotor arresting device, the latter comprises a control device which is arranged and designed to move the coupling element by means of the first actuator and/or by means of the second actuator from a release position into an arresting position, wherein the coupling element is releasably connected, preferably in a form-fitting manner, to the counterpart coupling element in the arresting position. In a further preferred embodiment variant of the rotor arresting device, the latter comprises a control device which is arranged and designed to move the coupling element in a first tangential direction of the rotation assembly by means of the first actuator and/or by means of the second actuator, wherein one of the actuators is preferably switched to a force-free state. The movement in the tangential direction is preferably provided by the first setting direction component or the second setting direction component of the coupling movement.

It is furthermore preferable that the rotor arresting device comprises a control device which is arranged and designed to move the first coupling element by means of the first actuator and/or by means of the second actuator of a first coupling device and/or the second coupling element by means of the first actuator and/or by means of the second actuator of a second coupling device from a release position into an arresting position, wherein the first coupling element and/or the second coupling element are or is releasably connected, preferably in a form-fitting manner, to one, two or more counterpart coupling elements.

A further particularly preferred embodiment variant of the rotor arresting device provides that the latter comprises a control device which is arranged and designed to move the first coupling element in a first tangential direction of the rotation assembly by means of the first actuator and/or by means of the second actuator, wherein one of the actuators is preferably switched to a force-free state, and/or to move the second coupling element in the first tangential direction of the rotation assembly by means of the first actuator and/or by means of the second actuator of the second coupling device, wherein one of the actuators is preferably switched to a force-free state. Since the setting direction components of the first and second coupling movement are directed in opposite directions, preferably only one actuator is actively involved, and the other actuator is switched to a force-free state, when carrying out such a movement in the tangential direction. It can thus be ensured that the movement of an actuator occurs only in the pressure direction or main force direction. Furthermore preferably, one of the actuators is not switched to a force-free state, but is loaded with a force which is less than the force of the other actuator, with the result that the stability of the coupling device can be improved.

Moreover, it is preferable that the rotor arresting device comprises a control device which is arranged and designed to move the first coupling element into an arresting position, then to move the second coupling element into a release position and in a second tangential direction and then to move the first coupling element in the first tangential direction, to move the second coupling element into an arresting position, then to move the first coupling element into a release position and in a second tangential direction and then to move the second coupling element in the first tangential direction. A rotor arresting device controlled in such a way means that the counterpart coupling element can be successively moved in the first tangential direction. Thus, the rotation assembly of the wind turbine can be moved with many small steps in the first tangential direction. It goes without saying that this movement direction can also occur counter to the above-described direction of rotation, for example that the rotation assembly or the counterpart coupling element is moved in the second tangential direction and the movement of the coupling element in the release position in turn occurs in the first tangential direction.

In a particularly advantageous embodiment variant of the rotor arresting device, the latter comprises a control device which is arranged and designed to move the first coupling element into an arresting position, then to move the second coupling element into a release position and in a second tangential direction and then to move the second coupling element into an arresting position. A control device arranged and designed in such a way can ensure that a movement in the tangential direction occurs only if both coupling elements of the two coupling devices present are situated in an arresting position. In a further preferred embodiment variant of the rotor arresting device, the latter comprises a control device which is arranged and designed to move the counterpart coupling element in the first tangential direction by multiple movement of the coupling elements according to at least one of the above-described movement sequences. An advantageous design of a control device results if the latter has two or more of the above-described designs of the control device.

According to a further aspect of the present invention, provided is a wind turbine having a rotor, a rotation assembly connected to the rotor in a rotationally rigid manner, and a static assembly which is positionally fixed relative to the rotation assembly, comprising a rotor arresting device according to at least one of the above-described embodiment variants.

According to a further aspect of the present invention, provided is a method for arresting a rotor of a wind turbine, in particular of a wind turbine according to the previous aspect, comprising providing a rotor arresting device according to at least one of the above-described embodiment variants, moving the coupling element by means of the first actuator and/or by means of the second actuator from a release position into an arresting position, wherein the first coupling element is releasably connected, preferably in a form-fitting manner, to the counterpart coupling element in the arresting position.

This method allows a rotor which is braked to substantially zero to be arrested. A rotor which is braked to substantially zero is distinguished in particular by the fact that it has a speed of rotation of substantially zero. The rotor braked to substantially zero also has, at its rotation assembly, a rate or speed of rotation of substantially zero, with the result that the at least one coupling element can be guided by the first actuator and/or the second actuator by means of a coupling movement toward the counterpart coupling element on the rotation assembly, and a releasable, preferably form-fitting, connection is produced by correspondingly bringing up or connecting the coupling element to the counterpart coupling element.

In particular, it is preferable that the method comprises braking and/or positioning the aerodynamic rotor before it is arrested.

In a particularly preferred embodiment variant of the method, the latter comprises moving the coupling element in a first tangential direction of the rotation assembly by means of the first actuator and/or by means of the second actuator, wherein one of the actuators is preferably switched to a force-free state. This method step affords the possibility that the rotor is arrested at a specific position. This occurs in particular by virtue of the fact that the rotation assembly, and hence also the rotor, is rotated by means of one of the actuators. This rotation occurs in particular by virtue of the fact that the first actuator and/or the second actuator move or moves the counterpart coupling element in a tangential direction of the rotation assembly, wherein the coupling element is situated in an arresting position in the meantime. Since the setting direction components of the coupling movement of the first actuator and of the second actuator are in opposite directions, it is particularly preferable that one of the actuators is switched to a force-free state during this movement, with the result that the force of the one actuator is not in opposition to the force of the other actuator.

According to a further aspect of the present invention, provided is a method for arresting a rotor of a wind turbine, in particular of a wind turbine according to an above-described embodiment variant, comprising providing a first rotor arresting device having a first coupling element, a first actuator and a second actuator according to at least one of the above-described embodiment variants, and providing a second rotor arresting device having a second coupling element, a third actuator and a fourth actuator according to at least one of the above-described embodiment variants, moving the first coupling element by means of the first actuator and/or by means of the second actuator and/or moving the second coupling element by means of the third actuator and/or by means of the fourth actuator from a release position into an arresting position, wherein the first coupling element and/or the second coupling element are or is releasably connected, preferably in a form-fitting manner, to the counterpart coupling element in the arresting position.

The second rotor arresting device comprises a third actuator and a fourth actuator, wherein the third actuator and the fourth actuator can be designed in a substantially identical or similar manner to the first actuator and/or the second actuator of the first rotor arresting device. Furthermore, the second rotor arresting device likewise comprises, in principle, a total of two actuators, namely the third actuator and the fourth actuator. This method allows the rotor or the rotation assembly having a counterpart coupling element to be arrested by two coupling elements.

In particular, it is preferable that the method comprises braking and/or positioning of the aerodynamic rotor before it is arrested.

According to a preferred embodiment variant of the method, the latter comprises moving the first coupling element in a first tangential direction of the rotation assembly by means of the first actuator and/or by means of the second actuator, wherein one of the actuators is preferably switched to a force-free state, and/or moving the second coupling element in the first tangential direction of the rotation assembly by means of the third actuator and/or by means of the fourth actuator, wherein one of the actuators is preferably switched to a force-free state.

A further preferred development of the method is distinguished by the method step of moving the first coupling element into an arresting position, then moving the second coupling element into a release position and in a second tangential direction and then moving the first coupling element in the first tangential direction, moving the second coupling element into an arresting position, then moving the first coupling element into a release position and in a second tangential direction and then moving the second coupling element in the first tangential direction.

Furthermore, the method preferably comprises the step of moving the first coupling element into an arresting position, then moving the second coupling element into a release position and in a second tangential direction and then moving the second coupling element into an arresting position. According to a further preferred embodiment variant of the method, the latter comprises the step of moving the counterpart coupling element in a first tangential direction by repeating at least one of the steps of the above-described embodiment variants.

The methods according to the invention and possible developments thereof have features or method steps which make them particularly suitable to be used for a rotor arresting device according to the invention and developments thereof. For further advantages, embodiment variants and embodiment details of these further aspects and possible developments thereof, reference is also made to the above description of the corresponding features and developments of the rotor arresting device.

### BRIEF DESCRIPTION OF THE SEVERAL VIEWS OF THE DRAWINGS

Preferred embodiments of the invention will be explained by way of example with reference to the appended figures, in which:

FIG. 1 shows a schematic view of an exemplary embodiment of a wind turbine;

FIG. 2 shows a schematic side view of an exemplary embodiment of a generator of a wind turbine according to FIG. 1;

FIG. 3 shows a schematic three-dimensional view of an exemplary embodiment of a rotor arresting device;

FIG. 4 shows a three dimensional view of a detail of an exemplary embodiment of a rotor arresting device.

In the figures, identical or substantially functionally identical or similar elements are designated with the same reference signs.

### DETAILED DESCRIPTION

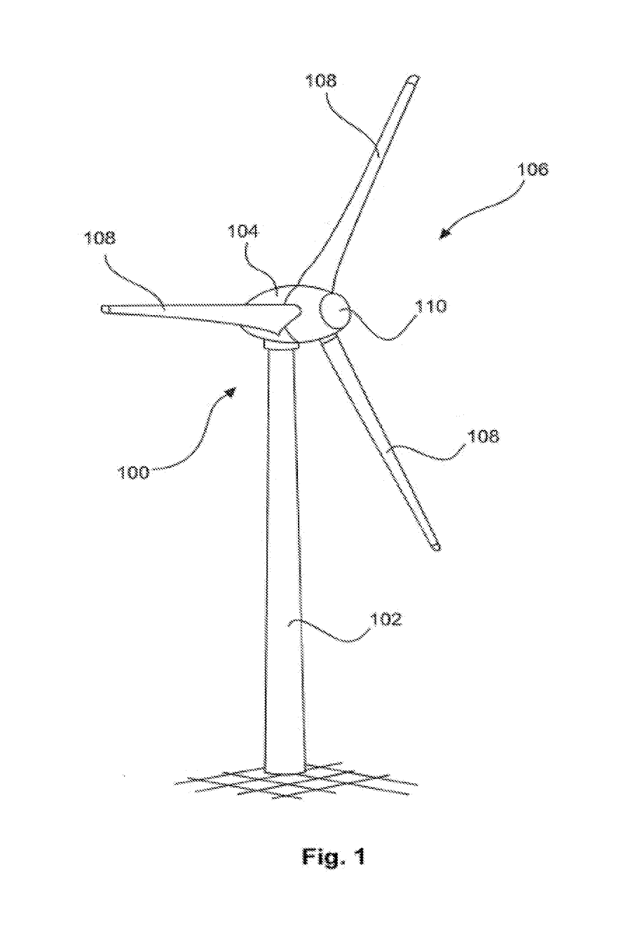

FIG. 1 shows a schematic view of an exemplary embodiment of a wind turbine. FIG. 1 shows, in particular, a wind turbine 100 having a tower 102 and a nacelle 104. An aerodynamic rotor 106 having three rotor blades 108 and a spinner 110 is arranged on the nacelle 104. In the installed state and/or in the operating state, the aerodynamic rotor 106 is set into a rotational movement by the wind and thus drives a generator in the nacelle 104. The aerodynamic rotor 106 thus also drives an electrodynamic rotor of a generator which is directly or indirectly coupled to the aerodynamic rotor 106. The electric generator is arranged in the nacelle 104 and generates electrical energy. The pitch angles of the rotor blades 108 can be varied by means of pitch motors on the rotor blade roots of the respective rotor blades 108.

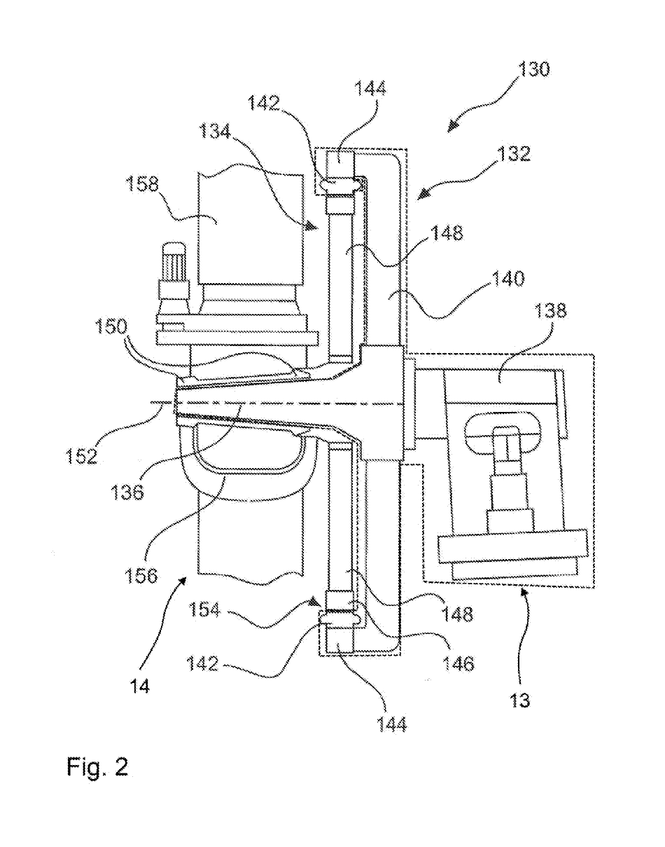

FIG. 2 schematically shows an inner-rotor generator 130 of the wind turbine 100 in a side view. It has a stator 132 and an electrodynamic rotor 134 mounted rotatably with respect thereto and is fastened by its stator 132 to a machine support 138 via a journal 136. The stator 132 has a stator support 140 and stator plate bundles 142 which form stator poles of the generator 130 and are fastened to the stator support 140 via a stator ring 144. The electrodynamic rotor 134 has rotor pole shoes 146 which form the rotor poles and are mounted so as to be rotatable about the axis of rotation 152 via a rotor support 148 and bearings 150 on the journal 136. The stator plate bundles 142 and rotor pole shoes 146 are separated by only a narrow air gap 154 which is a few millimeters thick, in particular less than 6 mm, but has a diameter of several meters, in particular more than 4 m. The stator plate bundles 142 and the rotor pole shoes 146 each form a ring and are together also ring-shaped, with the result that the generator 130 is a ring generator. As intended, the electrodynamic rotor 134 of the generator 130 rotates together with the rotor hub 156 of the aerodynamic rotor, of which starts of rotor blades 158 are indicated.

The inner-rotor generator 130 and the further shown elements of the wind turbine 100 comprise a static assembly 13 and a rotation assembly 14, wherein the static assembly 13 is enclosed by a dashed line for illustration. The static assembly 13 of this exemplary wind turbine comprises, for example, the machine support 138, the stator 132 with stator support 140, stator ring 144 and stator plate bundles 142, and the journal 136. The rotation assembly 14 of the partially shown wind turbine from FIG. 2 comprises, inter alia, the electrodynamic rotor 134 with the rotor support 148. These elements are connected to the aerodynamic rotor in a rotationally rigid manner and preferably have a common axis of rotation 152. The elements of the static assembly are arranged in a positionally fixed manner in relation to these elements of the rotation assembly. The static assembly comprises, for example, the machine support 138, the stator 132 with stator support 140, stator ring 144 and stator plate bundles 142, and the journal 136. As will be described below, rotor arresting devices according to the invention can be used to arrest the aerodynamic rotor 106.

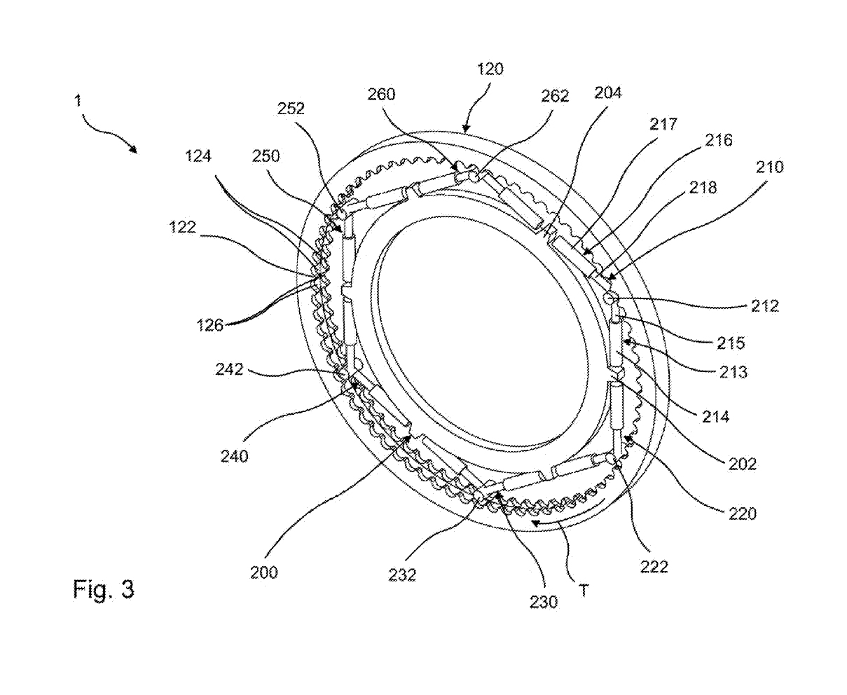

FIG. 3 shows a schematic three-dimensional view of an exemplary embodiment of a rotor arresting device. FIG. 3 shows, in particular, a rotor arresting device 1 having a first coupling device 210, a second coupling device 220, a third coupling device 230, a fourth coupling device 240, a fifth coupling device 250 and a sixth coupling device 260, each of which devices being arranged on a static assembly 200 which is positionally fixed relative to a rotation assembly. Moreover, the rotor arresting device 1 has a counterpart coupling device 120. The static assembly 200 has a ring-shaped geometry which has a center axis. The static assembly 200 also has a total of six projections, for example projection 202 or 204, which are arranged equidistantly on the outer radial circumferential surface of the static assembly. The counterpart coupling device 120, likewise ring-shaped, is arranged coaxially to the static assembly 200 and is preferably arranged on a rotation assembly (not shown) in a rotationally rigid manner.

The counterpart coupling device 120 has, moreover, a plurality of counterpart coupling elements which are designed here in the present case as toothing recesses. By way of example, the toothing recesses 124 and 126 are provided here with a reference sign, these two adjacent toothing recesses 124, 126 forming a tooth 122. The toothing recesses are arranged equidistantly on the inner circumferential surface of the counterpart coupling device 120. The toothing recesses are interrupted in certain regions in the axial direction. The interrupted part has a radius with respect to the center axis of the counterpart coupling device 120 which is greater than or equal to the radius from a low point of one of the toothing recesses to the center axis. It is thus possible for a cylindrical coupling element to be arranged in the toothing recesses and not to be influenced by the interrupted part.

All the toothing recesses on the counterpart coupling device 120 are designed in such a way that coupling elements 212, 222, 232, 242, 252, 262 can be arranged in these toothing recesses. The coupling elements 212 to 262 have a cylindrical geometry, the cylinder axis being oriented substantially parallel to the center axis of the static assembly 200 and of the counterpart coupling device 120. It is thus possible for the coupling elements 212 to 262 to have a part of their radial circumferential surface arranged within the toothing recesses, which are here in the present case semicircular. As a representative of all the coupling devices 210, 220, 230, 240, 250, 260 the detailed design of the coupling devices will be explained below on the basis of the first coupling device 210.

The coupling device 210 has a first actuator 213 and a second actuator 216. The first actuator 213 comprises a hydraulic cylinder 214 with an extendable cylinder element 215. Analogously to the first actuator 213, the second actuator 216 likewise has a hydraulic cylinder 217 with an extendable cylinder element 218. The first actuator 213 extends from a first end to a second end. The first actuator 213 is arranged by the first end on a first projection 202 of the static assembly 200 so as to be rotatable about an axis parallel to the center axis of the static assembly 200. The first coupling element 212 is arranged on the second end of the actuator 213, in particular on the end of the cylinder element 215 that faces away from the hydraulic cylinder 214. The second actuator 216 likewise extends from a first end to a second end. The second actuator 216 is likewise arranged by the first end on the static assembly 200. In particular, the second actuator 216 is arranged by its first end on a second projection 204, wherein the second projection 204 is arranged adjacent to the first projection 202. On the second end of the second actuator 216, in particular on the end of the cylinder element 218 that faces away from the hydraulic cylinder 217, the second actuator 216 is likewise rotatably connected to the first coupling element 212.

In the completely retracted state, that is to say that the cylinder elements 215, 218 are arranged as far as possible within the hydraulic cylinders 214, 217, the first actuator 213 and the second actuator 216 are oriented substantially tangentially to the static assembly 200. The coupling element is then situated in a release position and is in particular not releasably connected to one of the counterpart coupling elements, for example 124, 126. If the cylinder elements 215, 218 are now extended from the hydraulic cylinders 214, 217, the coupling element 212 moves with a coupling direction component in the direction of the counterpart coupling element 120. With sufficient extension of the cylinder elements 215, 218, the coupling element 212 is situated, with corresponding tangential positioning, in one of the toothing recesses of the counterpart coupling element 120.

The counterpart coupling device 120 can be securely arrested relative to the static assembly 200 through the arrangement of the coupling element 212 in one of the recesses of the counterpart coupling element. This is achieved in particular in that tangential forces of the counterpart coupling device are channeled via the coupling element into the actuators and from there are channeled to the static assembly 200.

Moreover, the counterpart coupling device 120 can also be rotated by the provided coupling devices 210 to 260 relative to the static assembly 200 in the tangential direction T. This preferably occurs by the first actuators extending their cylinder elements and the second actuators of the coupling device being switched to a force-free state. The rotation occurs in particular by virtue of the fact that the second coupling devices exert a smaller tangential force on the counterpart coupling device than is caused by the cylinder elements of the first actuators. After the first actuators have completely extended the cylinder elements, there can at first not take place any further rotation of the counterpart coupling device in relation to the static assembly 200. A coupling element of a coupling device is then preferably successively set back again into an arresting position counter to the direction of rotation, with the result that the coupling element is again arranged within a toothing recess and the coupling elements can carry out a repeated movement in the tangential direction of the desired direction of rotation.

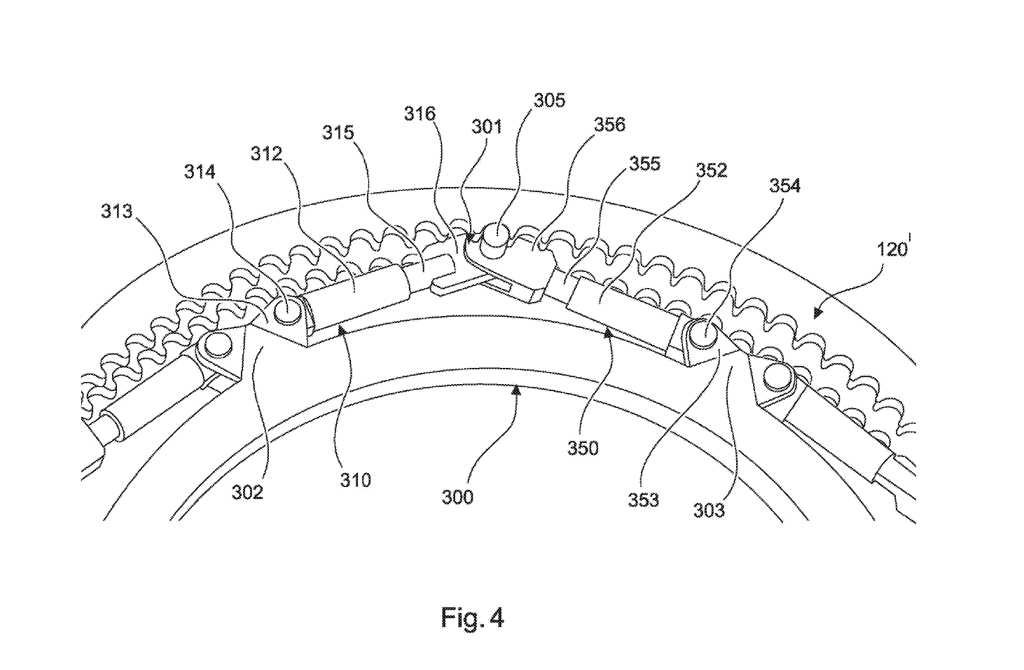

FIG. 4 shows a three-dimensional view of a detail of an exemplary embodiment of a rotor arresting device. The rotor arresting device 1′ comprises a coupling device 301 having a first actuator 310 and a second actuator 350, wherein the two actuators 310, 350 extend from a first end to a second end in an analogous manner to the previous description, wherein the first ends of the actuators 310, 350 are arranged on the static assembly on two adjacent projections 302, 303, and the second ends are each arranged on an individual coupling element 305. The coupling element 305 is situated in an arresting position in which the coupling element 305 is releasably connected to a counterpart coupling element of a counterpart coupling device 120′. In the present case, this connection is produced in a form-fitting manner in that the cylindrical coupling element 305 is arranged in a semicircular toothing recess.

Particularly evident in the present case is the rotatable arrangement of the actuators 310, 350 on the static assembly 300 and on the coupling element 305. The actuators 310, 350 are each fastened at their first end to the static assembly by a bolt receiving element 313, 353 and a bolt 314, 354. In the present case, the axis of rotation is again oriented parallel to the center axis of the static assembly 300.

The actuators 310, 350 each have, in particular in a region adjoining the first end, a preferably circular first opening, and are arranged with this region between openings of the bolt receiving elements 313, 353, with the result that a bolt can be arranged in the openings of the bolt receiving element, and is thus also arranged in the first openings of the first ends of the first actuator 310 and second actuator 350, and therefore nonrotational movements of the first ends of the actuators 310, 350 relative to the static assembly 300 are substantially prevented. It is thus possible to realize a rotatable arrangement of the actuators 310, 350 on the static assembly 300. The coupling element 305 is designed in the present case as a cylindrical element and can be used in the present case, also acting as a bolt, to connect the first actuator 310 and the second actuator 350 to one another. In an analogous manner to the counterpart coupling device 120, the counterpart coupling device 120′ has a plurality of counterpart coupling elements which are designed as semicircular toothing recesses.

The counterpart coupling device 120′ can be rotated relative to the static assembly 300 through this arrangement. This occurs in particular by virtue of the fact that a tangential force of the one actuator is greater than the oppositely directed tangential force of the respective other actuator. The actuator which is not used for the rotation of the counterpart coupling device 120′ is preferably switched to a force-free state. It is thus possible to achieve a preferably successive rotation of the counterpart coupling device 120′ in relation to the static assembly 300.

Rotor arresting devices 1, 1′ as shown in FIG. 3 and in FIG. 4 can also be used for arresting the aerodynamic rotor 106 as shown in FIG. 1 in that a counterpart coupling element 124, 126 is arranged in a rotationally rigid manner the rotation assembly and at least one coupling device 210, 220, 230, 240, 250, 260, 301 is arranged on the static assembly. For example, the counterpart coupling element 124, 126 can be arranged in a rotationally fixed manner on the end side of the rotor support 148 that faces the machine support 138. The at least one coupling device 210, 220, 230, 240, 250, 260, 301 is then preferably arranged on the end side of the stator support 140 that faces away from the machine support, with the result that the at least one coupling element 212, 222, 232, 242, 252, 262, 305 of the at least one coupling device 210, 220, 230, 240, 250, 260, 301 can be releasably connected to a counterpart coupling element 124, 126 of the counterpart coupling device 120, 120′.

The rotor arresting devices 1, 1′ shown in FIGS. 3 and 4 can be arranged, to arrest an aerodynamic rotor 106, on stator supports 140 and rotor supports 148 of inner-rotor generators and also of outer-rotor generators.

Particularly by virtue of the fact that the actuators, which are preferably designed as hydraulic elements, are arranged on the static assembly, the supply lines and control devices for them can be arranged without great difficulties. Moreover, many elements are situated on a rotation assembly of a wind turbine, on which elements a counterpart coupling device 120, 120′ can be arranged. Thus, a secure rotation of a rotor of a wind turbine can be achieved, with it being possible for the proposed rotor arresting device to be designed in a cost-effective manner. Moreover, given the large number of coupling devices to be arranged, said device offers a high safety factor which simplifies mounting and demounting, maintenance and repair work and other work in the region of the rotor and/or of the nacelle and reduces the effort for ensuring a controlled operation.

### REFERENCE SIGNS

1, 1′ Rotor arresting device
13 Static assembly
14 Rotation assembly
100 Wind turbine
102 Tower
104 Nacelle
106 Rotor
108 Rotor blade
110 Spinner
120, 120′ Counterpart coupling device
122 Tooth
124 First toothing recess
126 Second toothing recess
130 Inner-rotor generator
132 Stator
134 Electrodynamic rotor
136 Journal
138 Machine support
140 Stator support
142 Stator plate bundles
144 Stator ring
146 Rotor pole shoes
148 Rotor support
150 Bearings
152 Axis of rotation
154 Air gap
156 Rotor hub
158 Rotor blade
200, 300 Static assembly
202 First projection
204 Second projection
210 First coupling device
212 First coupling element
213 First actuator
214 Hydraulic cylinder
215 Cylinder element
216 Second actuator
217 Hydraulic cylinder
218 Cylinder element
220 Second coupling device
222 Second coupling element
230 Third coupling device
232 Third coupling element
240 Fourth coupling device
242 Fourth coupling element
250 Fifth coupling device
252 Fifth coupling element
260 Sixth coupling device
262 Sixth coupling element
301 Coupling device
302, 303 Projections
305 Coupling element
310 First actuator
312 Hydraulic cylinder
313 Bolt receiving element
314 Bolt
315 Cylinder element
316 Arrangement element
350 Second actuator
352 Hydraulic cylinder
353 Bolt receiving element
354 Bolt
355 Cylinder element
356 Arrangement element
T Tangential direction

1. A rotor arresting device for a wind turbine having a rotor and a rotation assembly coupled to the rotor in a rotationally rigid manner, the rotor arresting device comprising:
a coupling device configured to be arranged on a static assembly, wherein the static assembly is configured to be fixed relative to the rotation assembly of the wind turbine, the coupling device including:
a first actuator,
a second actuator, and
a coupling element coupled to the first and the second actuator,
a counterpart coupling element configured to be arranged on the rotation assembly,
wherein the coupling element and the counterpart coupling element are releasably connected in an arresting position of the coupling device,
wherein the coupling device is configured to move from a release position into the arresting position by at least one movement chosen from a first coupling movement of the first actuator and a second coupling movement of the second actuator, and
wherein the first coupling movement has a first setting direction component and the second coupling movement has a second setting direction component, wherein the first setting direction component and the second setting direction component are directed in opposite directions.

2. The rotor arresting device as claimed claim 1, wherein the first coupling movement has a first coupling direction component and the second coupling movement has a second coupling direction component, wherein the first coupling direction component and the second coupling direction component are directed in a same direction, and wherein the first coupling direction component and the second coupling direction component is directed from the coupling element to the counterpart coupling element.

3. The rotor arresting device as claimed in claim 1, wherein the coupling device is configured to move from the arresting position into the release position by at least one movement chosen from a first decoupling movement of the first actuator and a second decoupling movement of the second actuator, and
wherein the first decoupling movement has a first release direction component and the second decoupling movement has a second release direction component, wherein the first release direction component and the second release direction component are directed in opposite directions of each other.

4. The rotor arresting device as claimed in claim 1, wherein the first actuator and the second actuator are each configured to be activated independently of one another.

5. The rotor arresting device as claimed in claim 1, wherein the first actuator and the second actuator comprise extendable cylinders.

6. The rotor arresting device as claimed in claim 1, wherein the first actuator and the second actuator are configured to be rotatably arranged on the static assembly.

7. The rotor arresting device as claimed in claim 1, wherein the counterpart coupling element is arranged on a counterpart coupling device that is ring-shaped, wherein the counterpart coupling device configured to be arranged on the rotation assembly, wherein the counterpart coupling element is designed as a toothing recess, wherein the counterpart coupling element designed as a toothing recess substantially has a semicircular geometry, and the coupling element has a cylindrical geometry.

8. The rotor arresting device as claimed in claim 1, comprising a plurality of counterpart coupling elements that are semicircular toothing recesses that are spaced apart from one another by less than 45 degrees.

9. The rotor arresting device as claimed in claim 1, comprising at least one control device chosen among:
a control device configured to cause at least one actuator chosen from the first actuator and the second actuator to move the coupling element from a release position into an arresting position, wherein the coupling element is releasably connected to the counterpart coupling element in the arresting position; and
a control device configured to cause at least one actuator chosen from the first actuator and the second actuator to move the coupling element in a first tangential direction of the rotation assembly, wherein one of the first and second actuators is preferably switched to a force-free state.

10. The rotor arresting device as claimed in claim 1, comprising at least one control device chosen from:
a control device configured to cause at least one actuator chosen from the first actuator and the second actuator to move the first coupling element and the second coupling element from a release position into an arresting position, wherein the first coupling element and the second coupling element are releasably connected one or more counterpart coupling elements in the arresting position;
a control device configured to cause at least one actuator chosen from the first actuator and the second actuator to move the first and second coupling elements in a first tangential direction of the rotation assembly; and
a control device configured to cause at least one actuator chosen from the first actuator and the second actuator to move the first coupling element into an arresting position, to move the second coupling element into a release position and in a second tangential direction, to move the first coupling element in the first tangential direction, to move the second coupling element into an arresting position, to move the first coupling element into a release position and in a second tangential direction, and to move the second coupling element in the first tangential direction.

11. A wind turbine comprising:
a rotor, a rotation assembly coupled to the rotor in a rotationally rigid manner, and
a static assembly fixed relative to the rotation assembly, the static assembly comprising a rotor arresting device as claimed in claim 1.

12. A method for arresting the rotor of the wind turbine as claimed in claim 11, the method comprising:
using at least one actuator chosen from the first actuator and the second actuator, moving the coupling element from a release position into an arresting position, wherein the first coupling element is releasably connected to the counterpart coupling element in the arresting position.

13. A method for moving the rotor of the wind turbine as claimed in claim 11, the method comprising:
using at least one actuator chosen from the first actuator and the second actuator, moving the coupling element in a first tangential direction of the rotation assembly, wherein one of the first and second actuators is switched to a force-free state.

14. A method comprising:
arresting the rotor of the wind turbine as claimed in claim 11, wherein the rotor arresting device is a first rotor arresting device and the coupling element is a first coupling element, wherein the wind turbine includes a second rotor arresting device having a second coupling element, a third actuator and a fourth actuator, wherein arresting comprises;
using the first, second, third, and fourth actuators, moving the first coupling element and the second coupling element from a release position into an arresting position, wherein the first coupling element and the second coupling element are releasably connected to the counterpart coupling element in the arresting position.

15. The method as claimed in claim 14, comprising:
moving the first coupling element in a first tangential direction of the rotation assembly using at least one actuator chosen from the first actuator and the second actuator, wherein one of the first and second actuators is switched to a force-free state; and
moving the second coupling element in the first tangential direction of the rotation assembly using a least one actuator chosen from the third actuator and the fourth actuator, wherein one of the third and fourth actuators is switched to a force-free state.

16. The rotor arresting device as claimed in claim 1, wherein the coupling device is configured to move from the arresting position into the release position by at least one movement chosen from a first decoupling movement of the first actuator and a second decoupling movement of the second actuator, and
wherein the first decoupling movement has a first decoupling direction component and the second decoupling movement has a second decoupling direction component, wherein the first decoupling direction component and the second decoupling direction component are directed in a same direction as each other.

17. The rotor arresting device as claimed in claim 1, wherein the first actuator and the second actuator comprise hydraulic cylinders.

18. The rotor arresting device as claimed in claim 1, wherein the first actuator and the second actuator are rotatably connected to the coupling element.
